(19) United States
(12) Patent Application Publication
(10) Pub. No.: US 2010/0266383 A1
(43) Pub. Date: Oct. 21, 2010

(54) BALANCED SAIL WIND TURBINE

(76) Inventor: Kojo White, Taylor, MI (US)

Correspondence Address: FILDES & OUTLAND, P.C., 20916 MACK AVE., SUITE 2, GROSSE POINTE WOODS, MI, 48236, US

(21) Appl. No.: 12/759,282

(22) Filed: Apr. 13, 2010

Related U.S. Application Data
(60) Provisional application No. 61/171,156, filed on Apr. 21, 2009.

(51) Int. Cl. F03D 3/00

(52) U.S. Cl. 415/4.2

(57) ABSTRACT

A wind turbine includes a rotor rotatably mounted to a vertically disposed shaft. A plurality of circumferentially spaced elongated mounting arms extends radially from the rotor. A corresponding plurality of elongated generally planar sails extends along and is pivotally connected to the elongated arms. Sails are balancingly mounted on the arms and rest in a rest position generally at a 45° angle relative to a horizontal disposition when not acted upon by wind or rotor rotation. As the sails drive the rotor, the balanced sails move effortlessly into and out of alignment with the direction of current flow of the wind.

### CROSS REFERENCE TO RELATED APPLICATION

This application claims the priority of U.S. Provisional Patent Application No. 61/171,156 filed Apr. 21, 2009.

### TECHNICAL FIELD

This invention relates to renewable energy, and more particularly to a wind turbine for producing power.

### BACKGROUND OF THE INVENTION

It is known in the art relating to renewable energy to utilize a wind turbine to convert wind energy into electric power. One type of wind turbine is a horizontal axis wind turbine which has blades and a rotor that rotate about a horizontal axis. Horizontal axis wind turbines are typically very large and tall, are efficient, and can produce significant amounts of electricity. However, due to their large size, horizontal axis wind turbines are costly to install and require a significant amount of space. Therefore, horizontal axis wind turbines are not practical in densely populated, urban areas.

An alternative type of wind turbine is a vertical axis wind turbine which has a rotor that rotates about a vertical axis. Vertical axis wind turbines are typically smaller than horizontal axis wind turbines, and vertical axis wind turbines may be mounted on the ground or on a rooftop. Thus, vertical axis wind turbines have smaller space requirements than horizontal axis wind turbines and may be better suited for populated or urban areas. However, vertical axis wind turbines generally are less efficient than horizontal axis wind turbines.

### SUMMARY OF THE INVENTION

The present invention provides a vertical axis wind turbine having lightweight balanced sails. The present wind turbine has a compact and efficient design that is practical for use in generating wind energy in populated or urban areas. The present wind turbine also has a simple structure that can be produced at a low cost. Thus the present wind turbine can be utilized to cost effectively produce electric power from wind energy.

More particularly, a wind turbine in accordance with the present invention includes a rotor having a vertical axis mounted for rotation around a vertically disposed shaft. A plurality of circumferentially spaced elongated mounting arms extends radially from the rotor. A corresponding plurality of elongated generally planar sails extends along and is pivotally connected to the elongated arms. Sails are balancingly mounted on the arms and rest in a rest position generally at a 45° angle relative to a horizontal disposition when not acted upon by wind or rotor rotation.

Each of the elongated sails includes a top leading edge and a bottom trailing edge and at least two pivot points. Each pivot point is longitudinally spaced in the radial direction and is situated inward between the top leading edge and bottom trailing edge of the sail. A stop mounted on each arm limits the pivotal range of the sail around the arm. The stop provides two stop positions for stopping rotation of the sail. These positions are at a generally horizontal disposition and also at a generally vertical disposition.

In the disclosed embodiment, the stop is triangularly shaped and disposed on the elongated arm. The stop limits the pivotal movement of the sail within generally 90° or rotation around the arm.

A plurality of frames may frame and support each sail on the mounting arms although each sail may be frameless. In such a framed configuration the frames each include and or provide the pivot points and preferably the pivot points are defined in part by bearings.

A mount on the rotor mounts the rotor to the vertically disposed support shaft for rotation around the shaft. The mount also provides an attachment for attaching the mounting arms to the rotor. The mount may include a bearing that rides on the shaft or the mount may include an enlarged aperture for clearance around the vertically disposed support shaft.

A vertical axis wind turbine may include more than one plurality of mounting arm and sail assemblies vertically spaced along the rotor. And such a vertical axis wind turbine may include a spacer or spacers for maintaining spacing of the plurality of mounting arms and or mounts along the rotor.

These and other features and advantages of the invention will be more fully understood from the following detailed description of the invention taken together with the accompanying drawings.

### BRIEF DESCRIPTION OF THE DRAWINGS

In the drawings:

FIG. 1 is an exemplary perspective view of a balanced sail wind turbine in accordance with the present invention;

FIG. 2 is a sectional elevational view of the balanced sail wind turbine illustrating the rest disposition of a sail, at generally a 45° angle relative to a horizontal;

FIG. 3 is sectional elevational view of the balanced sail wind turbine illustrating an acted upon disposition of the sail and a stop stopping the sail in a vertical position; and

FIG. 4 is sectional elevational view of the balanced sail wind turbine illustrating the sail in a generally horizontal disposition parallel to air movement.

### DETAILED DESCRIPTION OF THE INVENTION

Referring now to the drawings in detail, numeral 10 generally indicates a wind turbine in accordance with the present invention. As is hereinafter more fully described, the wind turbine 10 includes balanced sails that efficiently take advantage of wind energy for subsequently generating electrical power while minimizing frictional wind losses.

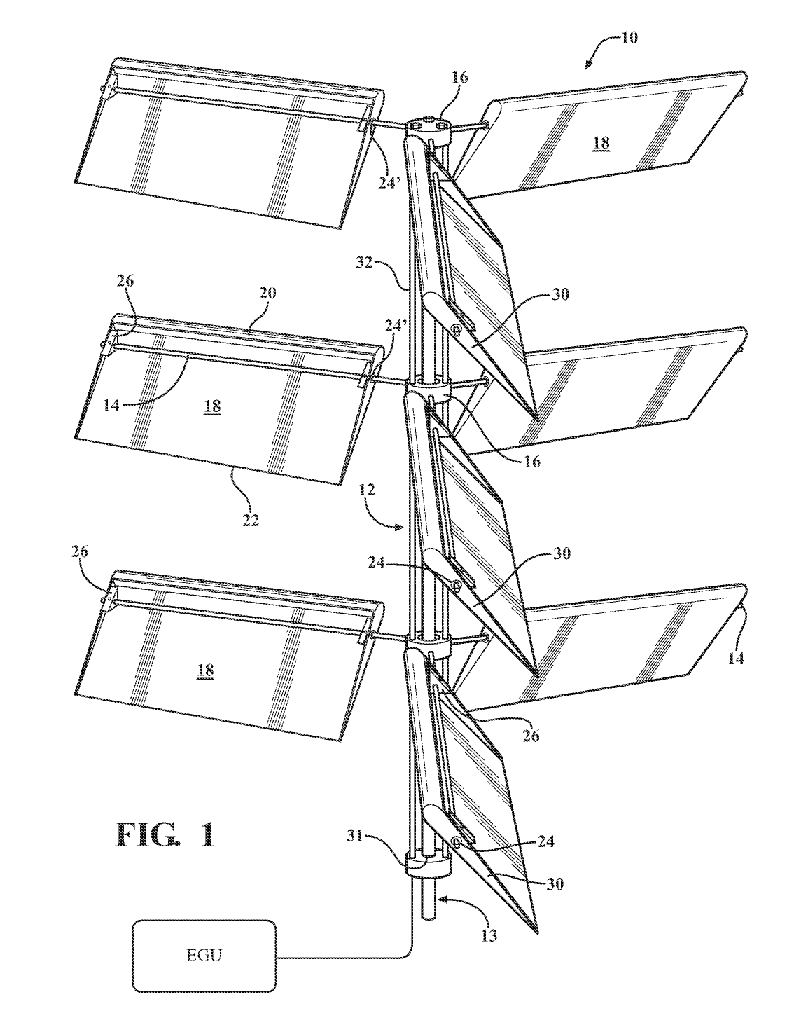

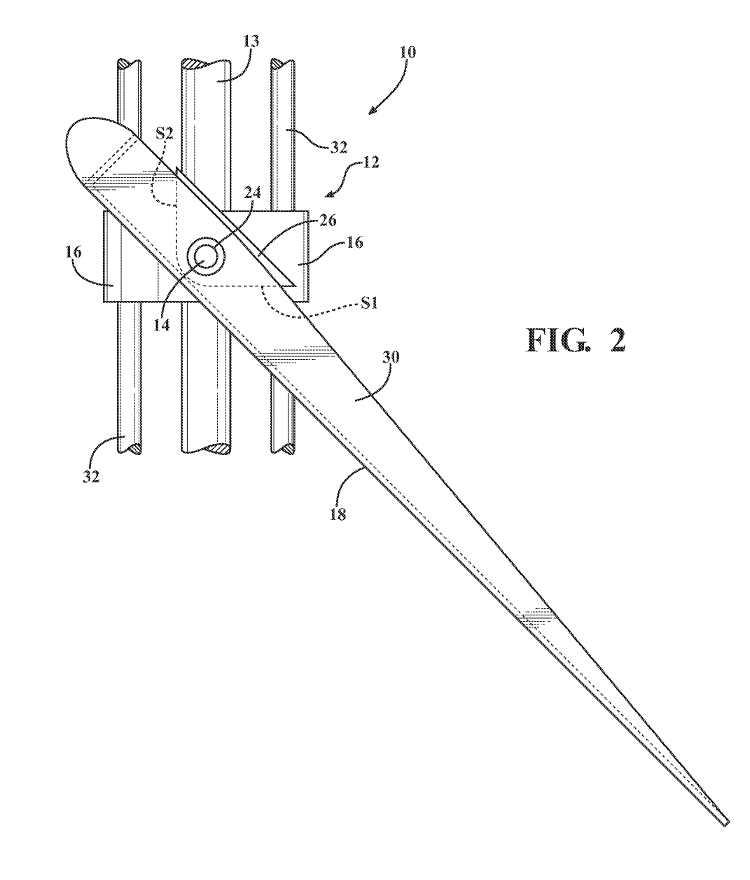

More specifically referring to FIGS. 1 and 2 wind turbine 10 includes a rotor 12 having a vertically disposed axis rotatably supported on a vertically disposed shaft. The wind turbine 10 is driveably connectable through known drive arrangements to an electrical generation unit, shown schematically as box EGU. A plurality of circumferentially spaced elongated mounting arms 14 extends radially from the rotor 12. Elongated mounting arms 14 may be connected directly to the rotor 12 by conventional fastening methods or as illustrated the elongated mounting arms may be connected through a mount 16 which forms part of the rotor.

A corresponding plurality of elongated, generally planar sails 18 extends along and is pivotally connected to the elongated arms 14. Sails 18 are each balancingly mounted on the arms and rest in a rest position generally at a 45° angle relative to a horizontal disposition when not acted upon by wind or rotor rotation. The sails may be constructed from a lightweight, flexible, durable material, although the sails are not limited to one specific material. The sails may be aerodynamically configured to further increase efficiency and reduce wind friction.

Each of the elongated sails 18 includes a top leading edge 20 and a bottom trailing edge 22 and at least two pivot points 24, 24′. Each pivot point 24, 24′ is longitudinally spaced from the other in the radial direction and is situated inward between the top leading edge 20 and bottom trailing edge 22 of the sail 18. The top leading edge 20 of the sail 18 may be counterweighted to maintain the balancingly mounted disposition of the sail on the elongated arm 14. Counter-weighting the top leading edge 20 also facilitates rotation of the sail 18 about the pivot points 24, 24′ away from the resting position, generally at a 45° angle relative to a horizontal.

A stop 26 is mounted on each arm 14 near the pivot points 24, 24′ of the arms and limits the pivotal range of the sail 18 around the arm. The stop 26 provides two stop positions S1, S2 for stopping rotation of the sail 18. These positions are at a generally horizontal disposition S1 and also at a generally vertical disposition S2.

In the illustrated embodiment, the stop 26 is triangularly shaped and disposed on the elongated arm 14. The stop 26 limits the pivotal movement of the sail within generally 90° of rotation. The stop precludes rotation of the sail 18 in both directions away from the resting disposition. Thus, the sails 18 are prevented from rotating all the way to beyond horizontal disposition S1 or beyond vertical disposition S2.

A plurality of frames 30 may frame and support each sail 18 on the mounting arms 14. In such a configuration the frames 30 each include and or provide the pivot points 24, 24′ and preferably the pivot points are defined in part by bearings.

Mount 16 which is part of the rotor 12 mounts the rotor to the vertically disposed support shaft 13 and allows the rotor to rotate around the shaft. Mount 16 also provides an attachment for attaching the mounting arms 14 to the rotor 14. A bearing 31 may be disposed in one or more mounts 16. In the illustrated exemplary embodiment, the top and bottom mounts 16 include bearings and the middle two mounts include large apertures that fit around the vertical shaft 13 without contact.

As illustrated the vertical axis wind turbine may include more than one plurality of mounting arm 14 and sail 18 assemblies vertically spaced along rotor 12 although one tier of mounting arms 14 and sails 18 are within the scope of the invention. And such a vertical axis wind turbine may include a spacer 32 which also forms part of the rotor 12 for maintaining spacing of the plurality of mounting arms 14 and or mounts 16 along the rotor.

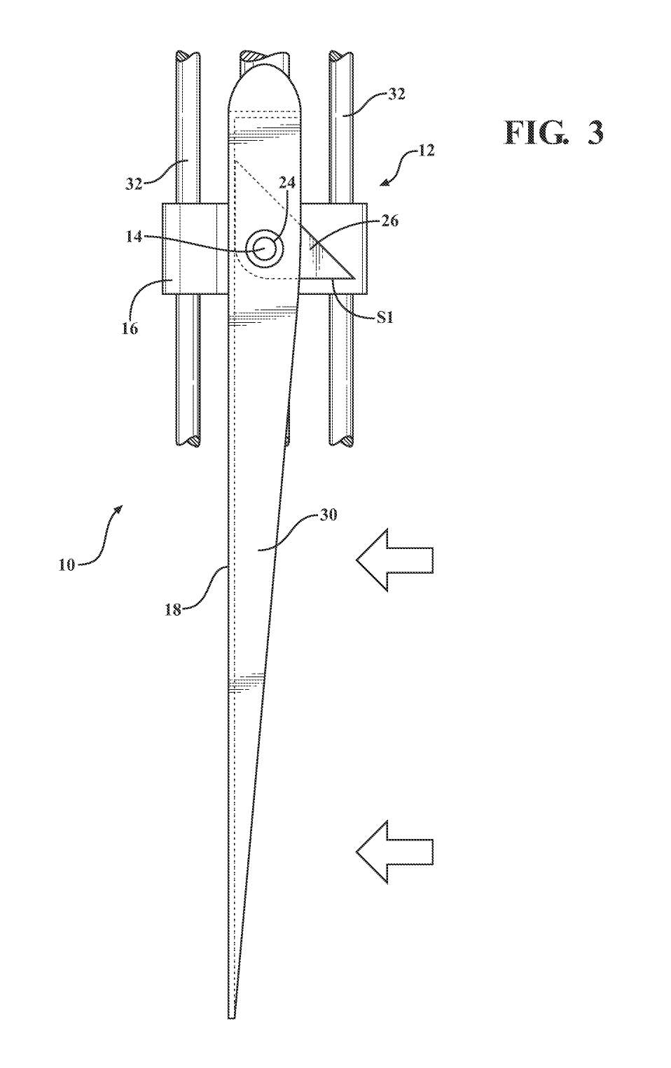

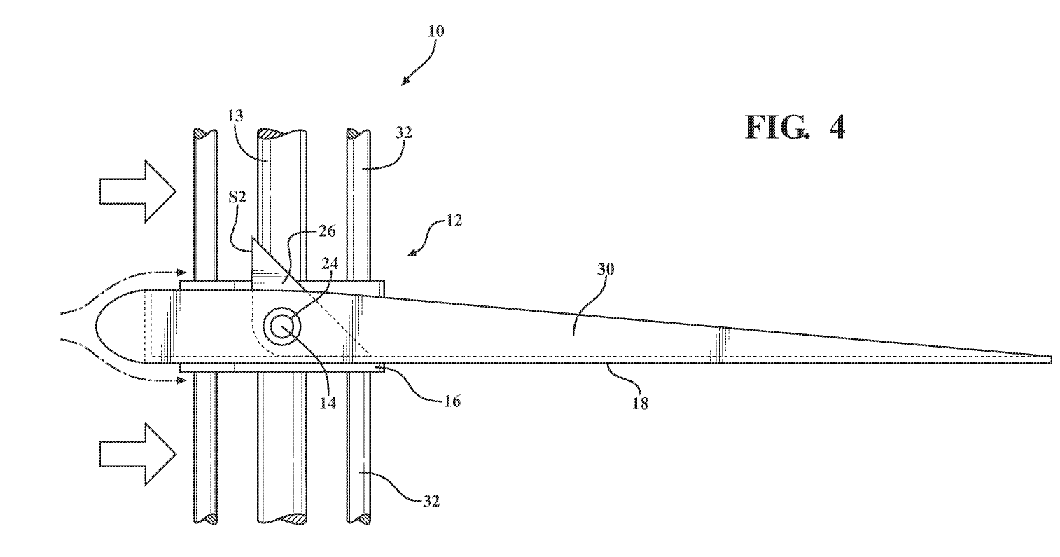

In use, when wind represented by arrows flows against sail 18 moving in a downwind direction (i.e., in line with the wind), the sail is rotated around arm 14 and stop 26 maintains the sail in the vertical disposition illustrated in FIG. 3. The force of the wind against the sail 18 rotates the rotor 12 and ultimately a generator to generate power in the form of electricity. As the same sail 18 turns the rotor 12 into an upwind direction (i.e., off-wind), the sail rotates about the pivot points 24, 24′ from the vertical disposition through the at rest 45° angle relative to a horizontal position, towards a horizontal disposition, thereby minimizing drag as the sail returns to a downwind position. The stops 26 halt the rotation of the sail 18 around the arm 14 as the sail reaches a horizontal disposition as illustrated in FIG. 4.

More specifically, as the sails 18 drive the rotor 12, the balanced sails move effortlessly into and out of alignment with the direction of current flow of the wind. When a sail 18 is aligned with (i.e., parallel to) the direction of current flow, the sail rests in the at rest 45° angle relative to a horizontal disposition. As a side of the sail 18 that is on the same side as the stop 26 moves into a position that faces the direction of current flow, the sail rotates to a vertical disposition and the stop precludes further rotation of the sail about its pivot points 24, 24′. Thus, the sail 18 remains in a generally vertical disposition, and the force of the wind against the sail rotates the rotor 12. As the sail 18 further continues to drive the rotor 12, the sail moves to its at rest position at which point it is again aligned with the current flow, and then the opposite side of the sail begins to face the direction of current flow. However, as the wind blows against the opposite side of the sail 18, the sail tilts from the at rest disposition towards the horizontal disposition as described above.

As the sail 18 continues to rotate the rotor 12, the side of the sail moves past a point at which it is perpendicular to the current flow. The sail then begins to return toward the resting disposition. The counter-weighted sail 18 is balanced and provides for smooth rotation of the sail as it pivots between its horizontal, off-wind non-driving, position S1 and vertical, on-wind driving, position S2 from its at rest disposition, generally at a 45° angle relative to a horizontal. The sail then returns to its starting point, completing one full revolution of the rotor, and the process repeats itself.

Although the present wind turbine has been illustrated as including three sets of arms and sails in a row, the present invention is not limited to a three sail embodiment and may have fewer or more sails. Also, although the present wind turbine has been described as generating electric power, the present wind turbine may be used in other applications to convert rotational motion into work.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. A vertical axis wind turbine comprising:
a rotor having a vertically disposed axis,
a plurality of circumferentially spaced elongated mounting arms operatively connected and extending radially from said rotor,
an equal plurality of elongated generally planar sails extending along and pivotally connected to said arms,
said sails being balancingly mounted on said arms to rest in a rest position generally at a 45° angle relative to a horizontal disposition when not acted upon.

2. The vertical axis wind turbine of claim 1 wherein each of said elongated sails includes a top leading edge and a bottom trailing edge and at least two pivot points, each pivot point being longitudinally spaced in the radial direction and inward between said top leading edge and bottom trailing edge of said sail.

3. The vertical axis wind turbine of claim 1 including a stop mounted on each arm to limit the pivotal range of said sail around said arm.

4. The vertical axis wind turbine of claim 4 wherein said stop provides two stop positions stopping said sail at a generally horizontal disposition and also at a generally vertical disposition.

5. The vertical axis wind turbine of claim 4 wherein said stop is triangularly shaped and disposed on said arm to limit the pivotal movement of said sail within generally 90° of rotation.

6. The vertical axis wind turbine of claim 1 including a plurality of frames each frame supporting a said sail on said mounting arms.

7. The vertical axis wind turbine of claim 6 wherein said frames each include said pivot points and said pivot points are defined in part by bearings.

8. The vertical axis wind turbine of claim 1 wherein said rotor includes a mount for mounting said rotor on a vertically disposed support shaft for rotation there around and providing an attachment for attaching said mounting arms thereto.

9. The vertical axis wind turbine of claim 1 including more than one plurality of mounting arm and sail assemblies vertically spaced along said rotor.

10. The vertical axis wind turbine of claim 9 wherein said rotor includes a spacer for maintaining spacing of the plurality of mounts along the rotor.
